(19) United States
(12) Patent Application Publication
(10) Pub. No.: US 2025/0350420 A1
(43) Pub. Date: Nov. 13, 2025

(54) METHOD AND APPARATUS FOR FULL DUPLEX IN WIRELESS COMMUNICATION SYSTEM

(71) Applicant: KT CORPORATION, Gyeonggi-do (KR)

(72) Inventor: Kyujin PARK, Gyeonggi-do (KR)

(73) Assignee: KT CORPORATION, Gyeonggi-do (KR)

(21) Appl. No.: 19/275,861

(22) Filed: Jul. 21, 2025

Related U.S. Application Data
(63) Continuation of application No. PCT/KR2024/000991, filed on Jan. 19, 2024.

(30) Foreign Application Priority Data
Jan. 20, 2023 (KR) 10-2023-0008484
Jan. 16, 2024 (KR) 10-2024-0006954

(51) Int. Cl. H04L 5/00; H04L 5/14

(52) U.S. Cl. CPC H04L 5/0044; H04L 5/14

(57) ABSTRACT

Provided are a method and an apparatus for performing DL transmission/reception and (UL transmission/reception in a wireless communication system. A base station transmits first UL-DL configuration information for DL symbols, UL symbols, and/or flexible symbols, and second UL-DL configuration information for SBFD symbols to a terminal. The terminal, based on the received first UL-DL configuration information and/or second UL-DL configuration information, configures at least one SBFD symbol for a DL subband and a UL subband. Based on the configured at least one SBFD symbol, the terminal performs DL reception through the DL subband and/or UL transmission through the UL subband. The at least one SBFD symbol is determined as a symbol for the DL reception and/or the UL transmission by: i) applying the second UL-DL configuration information through activation of a specific BWP, or ii) applying the first UL-DL configuration information through activation of a non-specific bandwidth part.

### TECHNICAL FIELD

The present disclosure relates to a 3GPP 5G NR system.

### BACKGROUND ART

As more communication devices require greater communication traffic, necessity for a next generation 5G system, which is enhanced compared to a legacy LTE system, is emerging. In the next generation 5G system, scenarios can be classified into Enhanced Mobile BroadBand (eMBB), Ultra-reliability and low-latency communication (URLLC), Massive Machine-Type Communications (mMTC), and the like.

Here, eMBB corresponds to a next generation mobile communication scenario having characteristics such as high spectrum efficiency, high user experienced data rate, high peak data rate, and the like. URLLC corresponds to a next generation mobile communication scenario having characteristics such as ultra-reliable, ultra-low latency, ultra-high availability, and the like (e.g., V2X, Emergency Service, Remote Control). mMTC corresponds to a next generation mobile communication scenario having characteristics such as low cost, low energy, short packet, and massive connectivity (e.g., IoT).

### DISCLOSURE OF INVENTION

### Technical Problem

One aspect of the present disclosure provides a method and an apparatus for configuring a bandwidth part (BWP) of a terminal and performing UL/DL transmission and reception operations based the configured BWP in a base station or cell where uplink (UL) subband and/or downlink (DL) subband configurations are set to support full duplex communication in a wireless communication system.

### Solution to Problem

In accordance with an embodiment, a method of a terminal in a wireless communication system may be provided for receiving first UL-DL configuration information for downlink (DL) symbols, uplink (UL) symbols, and/or flexible symbols, and second UL-DL configuration information for subband full duplex (SBFD) symbols, configuring at least one SBFD symbol for a UL subband and a DL subband based on the received first UL-DL configuration information and/or second UL-DL configuration information, and performing DL reception through the DL subband and/or UL transmission through the UL subband based on the configured at least one SBFD symbol. The at least one SBFD symbol is determined as a symbol for the DL reception and/or the UL transmission by: i) applying the second UL-DL configuration information through activation of a specific bandwidth part (BWP), or ii) applying the first UL-DL configuration information through activation of a non-specific bandwidth part.

In accordance with another embodiment, a communication apparatus in a wireless communication system may be provided. The apparatus may include: at least one processor; and at least one memory configured to store instructions and be operably electrically connectable to the at least one processor. Operations performed based on the instructions executed by the at least one processor may include: receiving first UL-DL configuration information for downlink (DL) symbols, uplink (UL) symbols, and/or flexible symbols, and second UL-DL configuration information for subband full duplex (SBFD) symbols; configuring, based on the received first UL-DL configuration information and/or second UL-DL configuration information, at least one SBFD symbol for a UL subband and a DL subband; and performing DL reception through the DL subband and/or UL transmission through the UL subband based on the configured at least one SBFD symbol, wherein the at least one SBFD symbol is determined as a symbol for the DL reception and/or the UL transmission by: i) applying the second UL-DL configuration information through activation of a specific bandwidth part (BWP), or ii) applying the first UL-DL configuration information through activation of a non-specific bandwidth part.

The specific bandwidth part may correspond to one DL/UL bandwidth part pair among DL/UL bandwidth part pairs configured for the terminal, and the non-specific bandwidth part may correspond to remaining DL/UL bandwidth part pairs excluding the specific bandwidth part.

Alternatively, the non-specific bandwidth part may correspond to DL/UL bandwidth part pairs configured for the terminal, and the specific bandwidth part may correspond to a specific DL/UL bandwidth part pair additionally configured beyond the DL/UL bandwidth part pairs configured for the terminal.

Further, the specific bandwidth part may be configured through radio resource control (RRC) signaling, may be determined as an initial DL/UL bandwidth part pair among the DL/UL bandwidth part pairs configured for the terminal, or may be determined as a DL/UL bandwidth part pair having a bandwidth part (BWP) identity of 0.

The first UL-DL configuration information and/or the second UL-DL configuration information may be received through radio resource control (RRC) signaling.

The DL reception through the DL subband may be performed as configured per DL channel and/or per DL signal, and the UL transmission through the UL subband is performed as configured per UL channel and/or per UL signal.

In addition, the UL transmission through the UL subband is performed based on whether repetitive transmission is configured for a UL channel and/or a UL signal.

Further, the first UL-DL configuration information and/or the second UL-DL configuration information may be cell-specific or UE-specific.

### Advantageous Effects of Invention

According to the embodiments, radio resources for full duplex communication can be efficiently utilized in a wireless communication system.

### BRIEF DESCRIPTION OF DRAWINGS

FIG. 1 illustrates a wireless communication system.

FIG. 2 illustrates a structure of a radio frame used in NR.

FIGS. 3A to 3C illustrate exemplary architectures for a wireless communication service.

FIG. 4 illustrates a slot structure of a new radio (NR) frame.

FIG. 5 shows an example of a subframe type in NR.

FIG. 6 illustrates a structure of a self-contained slot.

FIGS. 7A and 7B show schematic examples of subband full duplex communication.

FIGS. 8A and 8B show examples where an uplink (UL) subband is configured in a downlink (DL) slot according to an embodiment of the disclosure.

FIG. 9 shows a method of operating a terminal according to an embodiment of the disclosure.

FIG. 10 shows apparatuses according to an embodiment of the disclosure.

FIG. 11 is a block diagram showing a configuration of a terminal according to an embodiment of the disclosure.

FIG. 12 is a configuration block diagram of a processor in which the disclosure is implemented.

FIG. 13 is a detailed block diagram of a transceiver of a first apparatus shown in FIG. 10 or a transceiving unit of an apparatus shown in FIG. 11.

### MODE FOR THE INVENTION

The technical terms used herein are intended to merely describe specific embodiments and should not be construed as limiting the disclosure. Further, unless otherwise defined, the technical terms used herein should be interpreted as having meanings generally understood by those skilled in the art but not too broadly or too narrowly. Additionally, technical terms that do not precisely reflect the spirit of the disclosure should be replaced with, or understood as, technical terms that can be accurately understood by those skilled in the art. Finally, the general terms used herein should be interpreted in the context defined in the dictionary, but not in an excessively narrowed manner.

The expression of the singular form in the disclosure includes the meaning of the plural form unless the context explicitly requires otherwise. In the following description, the term ‘include’ or ‘have’ may represent the existence of a feature, a number, a step, an operation, a component, a part or the combination thereof described in the disclosure and may not exclude the existence or addition of any other feature, another number, another step, another operation, another component, another part or the combination thereof.

The terms ‘first’ and ‘second’ are used for the purpose of explanation about various components, and the components are not limited to the terms ‘first’ and ‘second’. The terms ‘first’ and ‘second’ are only used to distinguish one component from another component. For example, a first component may be named as a second component without departing from the scope of the disclosure.

It will be understood that when an element or layer is referred to as being “connected to” or “coupled to” another element or layer, it can be directly connected or coupled to the other element or layer or intervening elements or layers may be present. In contrast, when an element is referred to as being “directly connected to” or “directly coupled to” another element or layer, there are no intervening elements or layers present.

Hereinafter, exemplary embodiments of the disclosure will be described in greater detail with reference to the accompanying drawings. For clarity, the same reference numerals are used to denote the same components throughout the drawings, and repetitive description on the same components will be omitted. Descriptions of well-known techniques that may make the disclosure unclear will also be omitted. The accompanying drawings are provided merely to illustrate the spirit of the disclosure and should not be construed as limiting. It should be understood that the spirit of the disclosure includes modifications, replacements or equivalents in addition to what is shown in the drawings.

In the disclosure, “A or B” may mean “only A”, “only B”, or “both A and B”. In other words, “A or B” in the disclosure may be interpreted as “A and/or B”. For example, “A, B or C” in the disclosure may mean “only A”, “only B”, “only C”, or “any combination of A, B and C”.

In the disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the disclosure, “at least one of A and B” may mean “only A”, “only B” or “both A and B”. In addition, the expression “at least one of A or B” or “at least one of A and/or B” in the disclosure may be interpreted as the same as “at least one of A and B”.

In addition, in the disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the disclosure may indicate “for example”. For example, when presented as “control information (PDCCH)”, the “physical downlink control channel (PDCCH)” may be provided as an example of “control information”. In other words, “control information” in the disclosure is not limited to “PDCCH”, and “PDDCH” is merely an example of “control information”. Similarly, when shown as “control information (i.e., PDCCH)”, “PDCCH” may be provided as an example of “control information”.

The technical features described individually in one drawing in this specification may be implemented separately or at the same time.

In the accompanying drawings, user equipment (UE) is illustrated by way of example, but the illustrated UE may be also referred to as a terminal, mobile equipment (ME), or the like. In addition, the UE may be a portable device such as a laptop computer, a mobile phone, a PDA, a smart phone, a multimedia device, or the like, or may be a non-portable device such as a PC or a vehicle-mounted device.

Hereinafter, the UE is used as an example of a device capable of wireless communication (e.g., a wireless communication device, a wireless device, or a wireless apparatus). The operation performed by the UE may be performed by any device capable of wireless communication. A device capable of wireless communication may also be referred to as a radio communication device, a wireless device, or a wireless apparatus.

A base station, a term used below, generally refers to a fixed station that communicates with a wireless device, and may be used to cover the meanings of terms including an evolved-NodeB (eNodeB), an evolved-NodeB (eNB), a BTS (Base Transceiver System), an access point (Access Point), gNB (Next generation NodeB), RRH (remote radio head), TP (transmission point), RP (reception point), a repeater (relay), and so on.

Although embodiments of the disclosure will be described based on an LTE system, an LTE-advanced (LTE-A) system, and an NR system, such embodiments may be applied to any communication system falling within the above definitions.

### <Wireless Communication System>

With the success of long term evolution (LTE)/LTE-A (LTE-Advanced) for the 4th generation mobile communication, the next generation, i.e., 5^{th} generation (so called 5G) mobile communication has been commercialized and subsequent studies are ongoing.

The 5^{th} generation mobile communications defined by the International Telecommunication Union (ITU) refers to a system that provides a data transmission rate of up to 20 Gbps and a minimum actual transmission rate of at least 100 Mbps anywhere. The official name of the 5^{th} generation mobile telecommunications is ‘IMT-2020.’

The ITU proposes three usage scenarios, namely, enhanced Mobile Broadband (eMBB), massive Machine Type Communication (mMTC) and Ultra Reliable and Low Latency Communications (URLLC).

The URLLC relates to a usage scenario that requires high reliability and low latency. For example, services such as autonomous driving, factory automation, augmented reality require high reliability and low latency (e.g., a delay time of less than 1 ms). The latency for current 4G (LTE) is statistically 21 to 43 ms (best 10%) and 33 to 75 ms (median). This is insufficient to support a service requiring latency below 1 ms. Next, the eMBB usage scenario relates to a usage scenario requiring mobile ultra-wideband.

That is, the 5G mobile communication system supports higher capacity than the current 4G LTE and may increase the density of mobile broadband users and support device to device (D2D), high stability, and machine type communication (MTC). The 5G research and development also aims at a lower latency time and reduce battery consumption compared to a 4G mobile communication system to better implement the Internet of things. A new radio access technology (new RAT or NR) may be proposed for such 5G mobile communication.

An NR frequency band is defined as two types of frequency ranges: FR1 and FR2. The numerical value in each frequency range may vary, and the frequency ranges of the two types FR1 and FR2 may for example be shown in Table 1 below. For convenience of description, FR1 among the frequency ranges used in the NR system may refer to a Sub-6 GHz range, and FR2 may refer to an above-6 GHz range, which may be called millimeter waves (mmWs).

TABLE 1

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

The numerical values in the frequency range may vary in the NR system. For example, FR1 may range from 410 MHz to 7125 MHz as listed in [Table 1]. That is, FR1 may include a frequency band of 6 GHz (or 5850, 5900, and 5925 MHz) or above. For example, the frequency band of 6 GHZ (or 5850, 5900, and 5925 MHz) or above may include an unlicensed band. The unlicensed band may be used for various purposes, such as, vehicle communication (e.g., autonomous driving).

Meanwhile, the 3GPP communication standards define downlink (DL) physical channels corresponding to resource elements (REs) carrying information originating from a higher layer, and DL physical signals which are used in the physical layer and correspond to REs that do not carry information originated from a higher layer. For example, physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as DL physical channels, and reference signals (RSs) and synchronization signals (SSs) are defined as DL physical signals. A reference signal (RS), also called a pilot signal, is a signal with a predefined special waveform known to both a gNode B (gNB) and a UE. For example, cell specific RS, UE-specific RS (UE-RS), positioning RS (PRS), and channel state information RS (CSI-RS) are defined as DL RSs. The 3GPP LTE/LTE-A standards define uplink (UL) physical channels corresponding to REs carrying information originated from a higher layer, and UL physical signals which are used in the physical layer and correspond to REs which do not carry information originated from a higher layer. For example, physical uplink shared channel (PUSCH), physical uplink control channel (PUCCH), and physical random access channel (PRACH) are defined as UL physical channels, and a demodulation reference signal (DMRS) for a UL control/data signal, and a sounding reference signal (SRS) used for UL channel measurement are defined as UL physical signals.

In the disclosure, the PDCCH/PCFICH/PHICH/PDSCH refers to a set of time-frequency resources or a set of REs, which carry downlink control information (DCI)/a control format indicator (CFI)/a DL acknowledgement/negative acknowledgement (ACK/NACK)/DL data. Further, the PUCCH/PUSCH/PRACH refers to a set of time-frequency resources or a set of REs, which carry UL control information (UCI)/UL data/a random access signal.

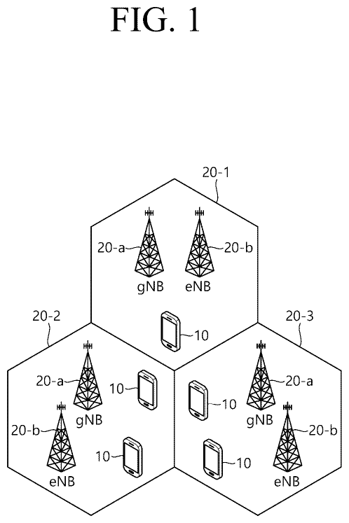

FIG. 1 illustrates a wireless communication system.

Referring to FIG. 1, the wireless communication system includes at least one base station (BS). The BS includes a gNodeB (or gNB) 20a and an eNodeB (or eNB) 20b. The gNB 20a supports the 5G mobile communication. The eNB 20b supports the 4G mobile communication, that is, long term evolution (LTE).

Each BS 20a and 20b provides a communication service for a specific geographic area (commonly referred to as a cell) (20-1, 20-2, 20-3). The cell may also be divided into a plurality of areas (referred to as sectors).

A user equipment (UE) typically belongs to one cell, and the cell to which the UE belongs is called a serving cell. A base station providing a communication service to a serving cell is referred to as a serving base station (serving BS). Since the wireless communication system is a cellular system, other cells adjacent to the serving cell exist. The other cell adjacent to the serving cell is referred to as a neighbor cell. A base station that provides a communication service to a neighboring cell is referred to as a neighbor BS. The serving cell and the neighboring cell are relatively determined based on the UE.

Hereinafter, downlink means communication from the base station 20 to the UE 10, and uplink means communication from the UE 10 to the base station 20. In the downlink, the transmitter may be a part of the base station 20, and the receiver may be a part of the UE 10. In the uplink, the transmitter may be a part of the UE 10, and the receiver may be a part of the base station 20.

Meanwhile, a wireless communication system may be largely divided into a frequency division duplex (FDD) scheme and a time division duplex (TDD) scheme. According to the FDD scheme, uplink transmission and downlink transmission are performed while occupying different frequency bands. According to the TDD scheme, uplink transmission and downlink transmission are performed at different times while occupying the same frequency band. The channel response of the TDD scheme is substantially reciprocal. This means that the downlink channel response and the uplink channel response are almost the same in a given frequency domain. Accordingly, in the TDD-based radio communication system, there is an advantage that the downlink channel response can be obtained from the uplink channel response. In the TDD scheme, since uplink transmission and downlink transmission are time-divided in the entire frequency band, downlink transmission by the base station and uplink transmission by the UE cannot be performed simultaneously. In a TDD system in which uplink transmission and downlink transmission are divided in subframe units, uplink transmission and downlink transmission are performed in different subframes.

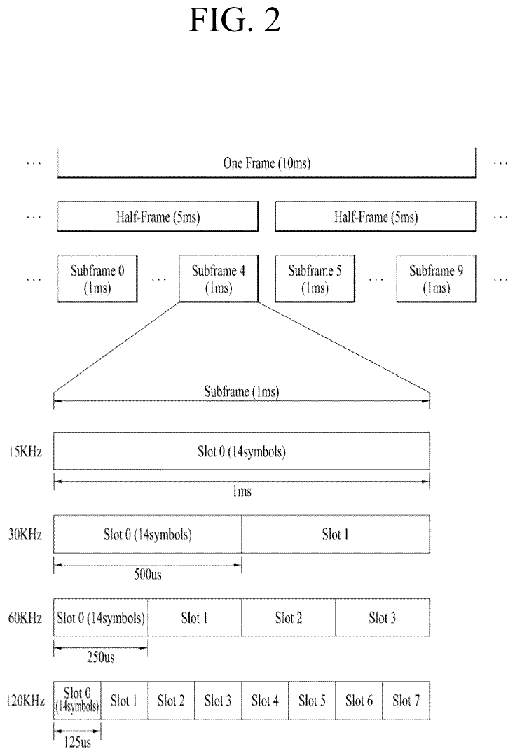

FIG. 2 illustrates a structure of a radio frame used in NR.

In NR, UL and DL transmissions are configured in frames. Each radio frame has a length of 10 ms and is divided into two 5-ms half frames (HFs). Each half frame is divided into five 1-ms subframes. A subframe is divided into one or more slots, and the number of slots in a subframe depends on an SCS. Each slot includes 12 or 14 OFDM (A) symbols according to a CP. When a normal CP is used, each slot includes 14 OFDM symbols. When an extended CP is used, each slot includes 12 OFDM symbols. A symbol may include an OFDM symbol (CP-OFDM symbol) and an SC-FDMA symbol (or DFT-s-OFDM symbol).

### <Support of Various Numerologies>

With the development of wireless communication technology, multiple numerologies may be available to UEs in the NR system. For example, in the case where a subcarrier spacing (SCS) is 15 kHz, a wide area of the typical cellular bands is supported. In the case where an SCS is 30 kHz/60 kHz, a dense-urban, lower latency, wider carrier bandwidth is supported. In the case where the SCS is 60 kHz or higher, a bandwidth that is greater than 24.25 GHz is supported in order to overcome phase noise.

The numerologies may be defined by a cyclic prefix (CP) length and a subcarrier spacing (SCS). A single cell can provide a plurality of numerologies to UEs. When an index of a numerology is represented by u, a subcarrier spacing and a corresponding CP length may be expressed as shown in the following table.

TABLE 2

| μ | Δf = 2^{μ} · 15 [kHz] | CP |
|---|---|---|
| 0 | 15 | normal |
| 1 | 30 | normal |
| 2 | 60 | normal, |
| | | extended |
| 3 | 120 | normal |
| 4 | 240 | normal |
| 5 | 480 | normal |
| 6 | 960 | normal |

In the case of a normal CP, when an index of a numerology is expressed by μ, the number of OLDM symbols per slot N^{slot}_{symb}, the number of slots per frame N^{frame,μ}ₛₗₒₜ, and the number of slots per subframe N^{subframe,μ}ₛₗₒₜ are expressed as shown in the following table.

TABLE 3

| | Δf = 2^{μ} · 15 | | | |
|---|---|---|---|---|
| μ | [kHz] | N^{slot}_{symb} | N^{frame, μ}ₛₗₒₜ | N^{subframe, μ}ₛₗₒₜ |
| 0 | 15 | 14 | 10 | 1 |
| 1 | 30 | 14 | 20 | 2 |
| 2 | 60 | 14 | 40 | 4 |
| 3 | 120 | 14 | 80 | 8 |
| 4 | 240 | 14 | 160 | 16 |
| 5 | 480 | 14 | 320 | 32 |
| 6 | 960 | 14 | 640 | 64 |

In the case of an extended CP, when an index of a numerology is represented by μ, the number of OLDM symbols per slot N^{slot}_{symb}, the number of slots per frame N^{frame,μ}ₛₗₒₜ, and the number of slots per subframe N^{subframe,μ}ₛₗₒₜ are expressed as shown in the following table.

TABLE 4

| μ | SCS (15*2^{u}) | N^{slot}_{symb} | N^{frame, μ}ₛₗₒₜ | N^{subframe, μ}ₛₗₒₜ |
|---|---|---|---|---|
| 2 | 60 KHz | 12 | 40 | 4 |
| | (u = 2) | | | |

In the NR system, OFDM (A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

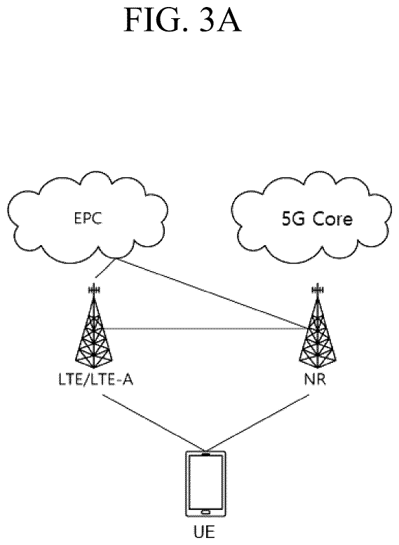

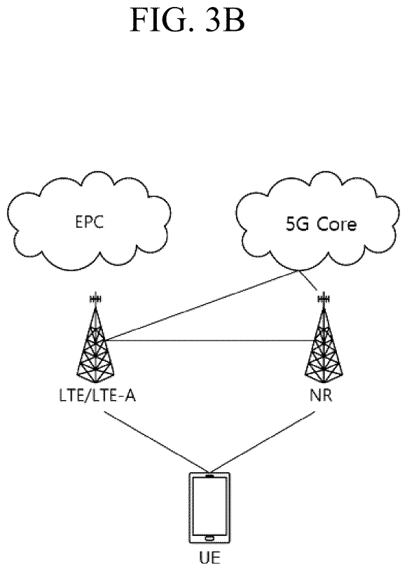

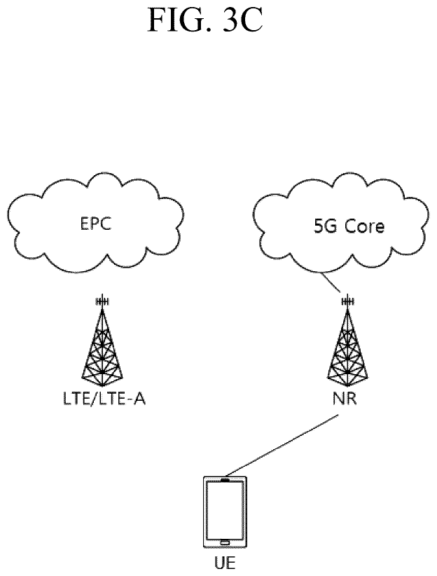

FIGS. 3A to 3C illustrate exemplary architectures for a wireless communication service.

Referring to FIG. 3A, a UE is connected in dual connectivity (DC) with an LTE/LTE-A cell and a NR cell.

The NR cell is connected with a core network for the legacy fourth-generation mobile communication, that is, an Evolved Packet core (EPC).

Referring to FIG. 3B, the LTE/LTE-A cell is connected with a core network for 5th generation mobile communication, that is, a 5G core network, unlike the example in FIG. 3A.

A service based on the architecture shown in FIGS. 3A and 3B is referred to as a non-standalone (NSA) service.

Referring to FIG. 3C, a UE is connected only with an NR cell. A service based on this architecture is referred to as a standalone (SA) service.

Meanwhile, in the aforementioned new radio access technology (NR), using a downlink subframe for reception from a base station and using an uplink subframe for transmission to the base station may be considered. This method may be applied to both paired and unpaired spectrums. A pair of spectrums refers to two subcarriers for downlink and uplink operations. For example, one subcarrier in one pair of spectrums may include a pair of a downlink band and an uplink band.

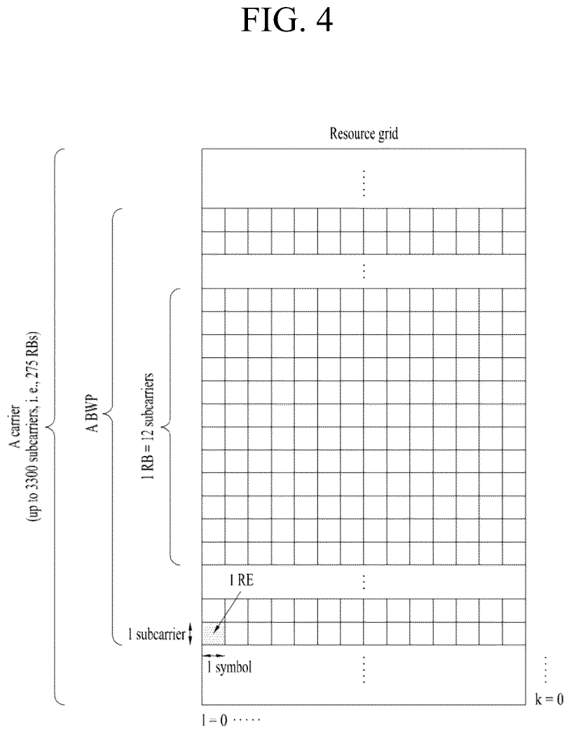

FIG. 4 illustrates a slot structure of an NR frame.

A slot includes a plurality of symbols in the time domain. For example, in the case of the normal CP, one slot includes seven symbols. On the other hand, in the case of an extended CP, one slot includes six symbols. A carrier includes a plurality of subcarriers in the frequency domain. A resource block (RB) is defined as consecutive subcarriers (e.g., 12 consecutive subcarriers) in the frequency domain. A bandwidth part (BWP) is defined as a plurality of consecutive physical resource blocks (PRB) s in the frequency domain and may correspond to one numerology (e.g., SCS, CP length, etc.). A UE may be configured with up to N (e.g., five) BWPs in both the downlink and the uplink. The downlink or uplink transmission is performed through an activated BWP, and only one BWP among the BWPs configured for the UE may be activated at a given time. In the resource grid, each element is referred to as a resource element (RE), and one complex symbol may be mapped thereto.

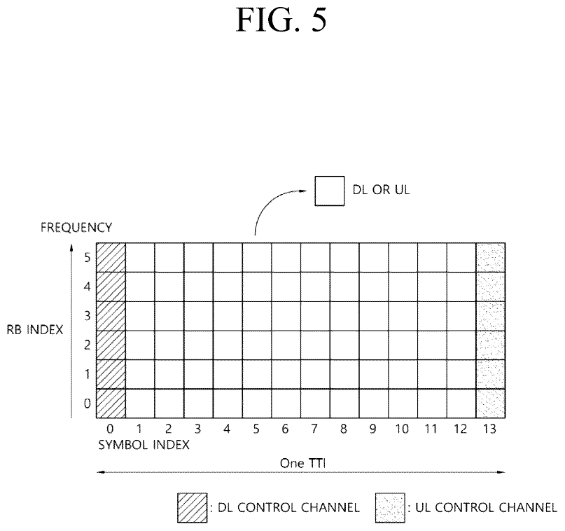

FIG. 5 shows an example of a subframe type in NR.

Referring to FIG. 5, a TTI (Transmission Time Interval) may be called a subframe or a slot for NR (or new RAT). The subframe (or slot) shown in FIG. 5 can be used in a TDD system of NR (or new RAT) to minimize data transmission delay. As shown in FIG. 5, a subframe (or slot) includes 14 symbols. The symbol at the head of the subframe (or slot) can be used for a DL control channel and the symbol at the end of the subframe (or slot) can be used for a UL control channel. The remaining symbols can be used for DL data transmission or UL data transmission. According to this subframe (or slot) structure, downlink transmission and uplink transmission can be sequentially performed in one subframe (or slot). Accordingly, downlink data can be received in a subframe (or slot) and uplink ACK/NACL may be transmitted in the subframe (or slot).

Such a subframe (or slot) structure may be called a self-contained subframe (or slot).

Specifically, the first N symbols (hereinafter referred to as the DL control region) in a slot may be used to transmit a DL control channel, and the last M symbols (hereinafter referred to as the UL control region) in the slot may be used to transmit a UL control channel. N and M are integers greater than 0. A resource region between the DL control region and the UL control region (hereinafter referred to as a data region) may be used for DL data transmission or UL data transmission. For example, a physical downlink control channel (PDCCH) may be transmitted in the DL control region, and a physical downlink shared channel (PDSCH) may be transmitted in the DL data region. A physical uplink control channel (PUCCH) may be transmitted in the UL control region, and a physical uplink shared channel (PUSCH) may be transmitted in the UL data region.

When this subframe (or slot) structure is used, a time taken to retransmit data that has failed in reception may be reduced to minimize final data transmission latency. In such a self-contained subframe (or slot) structure, a time gap may be required in a process of transition from a transmission mode to a reception mode or from the reception mode to the transmission mode. To this end, some OFDM symbols when DL switches to UL in the subframe structure can be configured to a guard period (GP).

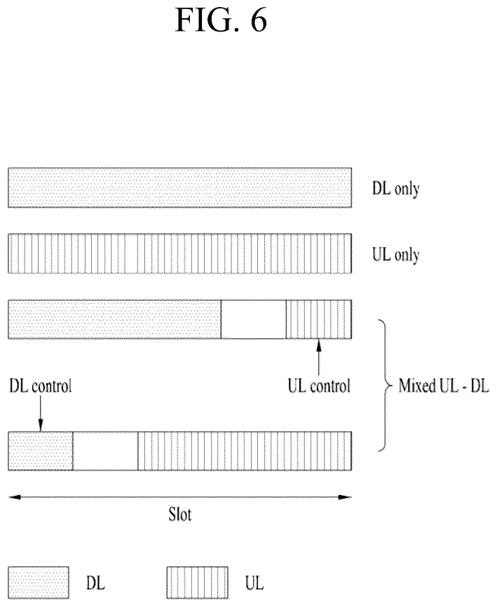

FIG. 6 illustrates a structure of a self-contained slot.

In the NR system, the frame has a self-contained structure, in which all of a DL control channel, DL or UL data channel, UL control channel, and other elements are included in one slot. For example, the first N symbols (hereinafter referred to as a DL control region) in a slot may be used for transmitting a DL control channel, and the last M symbols (hereinafter referred to as an UL control region) in the slot may be used for transmitting an UL control channel. N and M are integers greater than 0. A resource region between the DL control region and the UL control region (hereinafter referred to as a data region) may be used for DL data transmission or UL data transmission. For example, the following configurations may be taken into account. The durations are listed in temporal order.
1. DL only configuration
2. UL only configuration
3. Mixed UL-DL configuration
   DL region+Guard Period (GP)+UL control region
   DL control region+GP+UL region
DL region: (i) DL data region, (ii) DL control region+DL data region
UL region: (i) UL data region, (ii) UL data region+UL control region

A PDCCH may be transmitted in the DL control region, and a PDSCH may be transmitted in the DL data region. A PUCCH may be transmitted in the UL control region, and a PUSCH may be transmitted in the UL data region. In the PDCCH, Downlink Control Information (DCI), for example, DL data scheduling information or UL data scheduling data may be transmitted. In the PUCCH, Uplink Control Information (UCI), for example, ACK/NACK (Positive Acknowledgement/Negative Acknowledgement) information with respect to DL data, Channel State Information (CSI) information, or Scheduling Request (SR) may be transmitted. A GP provides a time gap during a process where a gNB and a UE transition from the transmission mode to the reception mode or a process where the gNB and UE transition from the reception mode to the transmission mode. Part of symbols belonging to the occasion in which the mode is changed from DL to UL within a subframe may be configured as the GP.

### <Disclosures of the Present Specification>

Time division duplex (TDD) refers to a duplexing method widely used in commercial NR, i.e., a 5G mobile communication system. In TDD, time-segment radio resources are divided into downlink slots and uplink slots, where the downlink slots are typically distributed in a higher percentage than the uplink slots according to the distribution ratio of uplink traffic and downlink traffic. However, such a limitation of the uplink slot distribution has negative effects in terms of coverage and delay time. Recently, full duplex communication has attracted increasing attention as a technology to solve such a problem.

The full duplex communication refers to technology in which the gNB, i.e., the base station performs DL transmission and UL reception simultaneously through the same (or given) radio resources. The UE may also perform DL reception and UL transmission simultaneously. In other words, both the base station and the UE may support full duplex communication. However, unlike the base station where self-interference cancelation is structurally feasible, the UE has DL reception performance that is vulnerable to self-interference from a UL transmission signal. Therefore, it is generally considered preferable to operate the gNB in full duplex communication and operate the UE in half duplex communication. In addition, the gNB may also primarily consider a subband non-overlapping full duplex method in which it performs DL transmission and UL reception simultaneously, but uses different frequency resources for transmission and reception, rather than the same resources between the DL and UL to reduce the effects of self-interference.

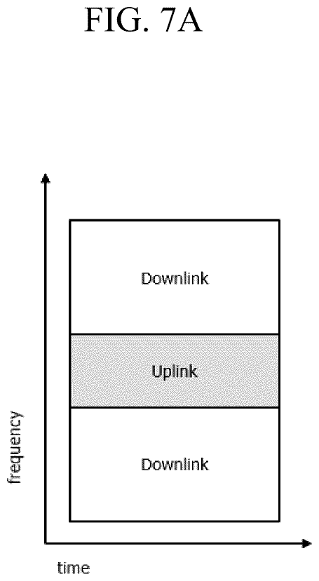

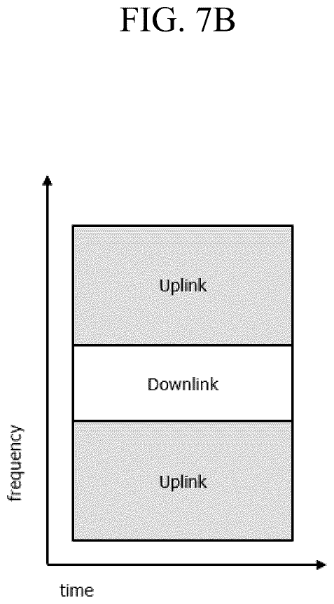

FIGS. 7A and 7B show schematic examples of subband full duplex communication.

The subband full duplex communication may be referred to as subband full duplex communication (SBFD) or full duplex communication subband (FDSB).

In SBFD, some time-frequency resources on a given carrier are used for the downlink, and some time-frequency resources on the same carrier are used for the uplink. Specifically, the downlink resources and the uplink resources are separated from each other in the frequency domain and used for transmission and reception.

FIGS. 7A and 7B show examples of SBFD. In the frequency domain, FIG. 7A shows an example where an uplink subband is located between downlink subbands, and FIG. 7B shows an example where the downlink subband is located between the uplink subbands. Although not shown in the drawings, a guard band or guard period may be located between the downlink subband and the uplink subband to reduce interference.

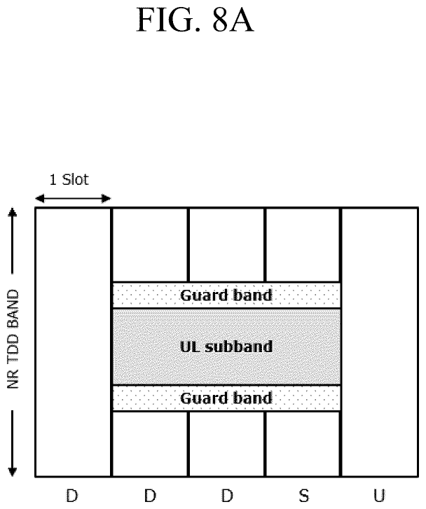

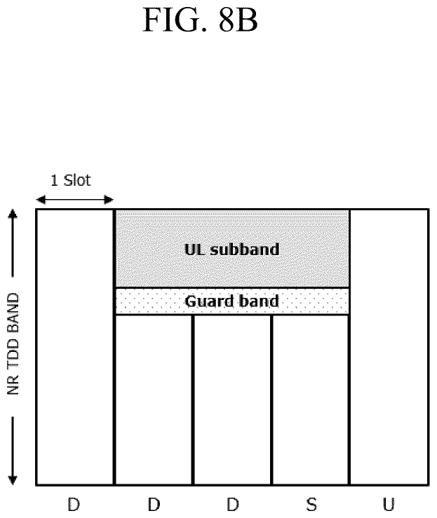

FIGS. 8A and 8B show examples where an uplink (UL) subband is configured in a downlink (DL) slot according to an embodiment of the disclosure.

Referring to FIGS. 8A and 8B, if the TDD is configured at a ratio of 4:1 between DL slots and UL slots in any NR frequency band (where, the last DL slot is a special slot of which some symbols include flexible symbols for DL/UL transition), the UL subband may be configured to support the UL transmission of the UE in some (or all) DL slots among the corresponding DL slots. When the UL subband is configured in a DL slot, the UL subband may be configured either at the center or at the edge of the corresponding frequency band, and a guard band may be configured between the UL subband and the DL subband in the corresponding slot.

In the current NR specification, the UL-DL slots are defined to be configured in units of cells through cell-specific RRC signaling. In other words, the patterns of DL symbol, UL symbol, and flexible symbol having certain periods are configured through ‘tdd-UL-DL-ConfigurationCommon’, i.e., the RRC message/information for the corresponding UL-DL slot configuration. In addition, only the flexible symbol configured through the ‘tdd-UL-DL-ConfigurationCommon’ may be reallocated to the UL symbol, DL symbol or flexible symbol through the UE-specific RRC signaling, i.e., ‘tdd-UL-DL-ConfigurationDedicated’. Alternatively, a method of indicating a dynamic slot format through a UE-group common PDCCH has also been defined. To this end, the NR also supports a dynamic slot format indication method through DCI format 2_0.

According to the existing slot configuration method described above, each individual symbol may be configured or indicated as the DL, UL or flexible symbol. That is, FIGS. 8A to 8B illustrate examples in which a slot format is configured as DDDSU through slot configuration. Here, D refers to a downlink slot and means that all OFDM symbols constituting the corresponding slot are configured as DL. U refers to an uplink slot and means that all OFDM symbols constituting the corresponding slot are configured to UL. S refers to a special slot and means that flexible symbols for DL/UL transition are included in the corresponding slot. Generally, the corresponding special slot in the case of a normal CP may include a total of 14 symbols, i.e., 12 DL symbols and 2 flexible symbols. Alternatively, the special slot may include 10 DL symbols, 2 flexible symbols, and 2 UL symbols. That is, one symbol in any TDD carrier is configured or indicated as only one of the DL, UL, or flexible symbols.

However, as shown in FIGS. 8A and 8B, when the UL subband is configured in a DL slot, the DL transmission or UL transmission may occur simultaneously for each frequency resource in the corresponding symbol. In this way, the DL slot or symbol including the UL subband, or the UL slot or symbol including the DL subband sis referred to as an SBFD slot or SBFD symbol in this specification.

According to the existing TDD UL-DL configuration information, unless a slot or symbol is configured/indicated as flexible, it is configured/indicated as either DL or UL by the base station. The UE then performs reception of downlink channels (e.g., PDCCH, PDSCH) or downlink signals (e.g., CSI-RS, PSS/SSS (primary synchronization signal/secondary synchronization signal), PRS (positioning reference signal)) via DL slots or symbols, and performs transmission of uplink channels (e.g., PUCCH, PUSCH, PRACH) or uplink signals (e.g., SRS) via UL slots or symbols. In contrast, for SBFD symbols that include or constitute UL subbands, as shown in FIGS. 8A to 8B, both DL reception through a DL subband and UL transmission through a UL subband may be performed simultaneously, and therefore a clear definition of the operations to be performed by the UE is required.

The present disclosure proposes uplink transmission and downlink reception operations of a UE in an SBFD symbol that includes UL subbands and DL subbands. In particular, the present disclosure proposes a method of a UE for configuring a bandwidth part (BWP), transmitting uplink, and receiving downlink based on the configured BWP when the base station configures a UL subband or DL subband and defines SBFD symbols.

### First Disclosure: Definition of SBFD BWP

To perform SBFD operation and resource allocation, the base station may configure an SBFD BWP for a terminal. That is, an SBFD BWP may be defined separately from the typical DL BWP and UL BWP. In this case, the SBFD BWP may be further divided into an SBFD-DL BWP and an SBFD-UL BWP. The SBFD-DL BWP is a BWP for downlink reception within an SBFD symbol. Through the configuration and activation of the SBFD-DL BWP, the base station may configure or indicate (e.g., instruct) a terminal to perform downlink reception through a DL subband in an SBFD symbol. Similarly, the SBFD-UL BWP is a BWP for uplink transmission in an SBFD symbol. Through the configuration and activation of the SBFD-UL BWP, the base station may configure or indicate (e.g., instruct) a terminal to perform uplink transmission through a UL subband in an SBFD symbol.

As one method of configuring and/or activating the SBFD-DL BWP and the SBFD-UL BWP, the SBFD-DL BWP may be configured to have a linkage relationship with a UL BWP, and the SBFD-UL BWP may be configured to have a linkage relationship with a DL BWP. Specifically, the SBFD-DL BWP configured for a terminal may have the same BWP index as one of the UL BWPs configured for that terminal. The SBFD-UL BWP may have the same BWP index as one of the DL BWPs configured for that terminal. In this case, as in typical configurations, the terminal is not expected to support configurations where the SBFD-DL BWP and the linked UL BWP, or the SBFD-UL BWP and the linked DL BWP, have different center frequencies. In addition, it may be restricted such that the SBFD-DL BWP and the SBFD-UL BWP are not activated simultaneously at the terminal.

When the base station configures and activates an SBFD-DL BWP for a terminal, the terminal may perform downlink reception in a slot or symbol configured as DL by using the entire frequency range of the SBFD-DL BWP, based on downlink resource allocation information received from the base station. In contrast, in a slot or symbol configured as SBFD (i.e., a slot or symbol including a UL subband, a DL subband, and a guard band), the terminal may perform downlink reception only in the frequency range corresponding to the DL subband as indicated by the downlink resource allocation information received from the base station.

When the base station configures and activates an SBFD-UL BWP for a terminal, the terminal may perform uplink transmission in a slot or symbol configured as UL by using the entire frequency range of the SBFD-UL BWP, based on uplink resource allocation information received from the base station. In contrast, in a slot or symbol configured as SBFD (i.e., a slot or symbol including a UL subband, a DL subband, and a guard band), the terminal may perform uplink transmission only in the frequency range corresponding to the UL subband, as indicated by uplink resource allocation information received from the base station.

Additionally, the base station may be defined to configure or indicate (e.g., instruct) the terminal with a configured and activated SBFD-DL BWP whether to support downlink reception through the UL subband within an SBFD symbol. That is, when an SBFD-DL BWP is configured and activated for a given terminal, as described above, the terminal supports reception of downlink physical channels and physical signals over the entire frequency resources of the SBFD-DL BWP, including the frequency range of the UL subband, in DL-configured slots or symbols. In contrast, in SBFD-configured slots or symbols, the terminal may be defined to support, as a baseline operation, reception of downlink physical channels and physical signals only over the frequency resources belonging to the DL subband, excluding the UL subband and the guard band, within the SBFD-DL BWP. However, the base station configures or indicates the terminal behavior when resource allocation includes frequency resources belonging to the UL subband or the guard band. In this case, for downlink resource allocation that includes UL subband frequency resources or guard band frequency resources, the terminal may be defined to operate according to three main operation options: dropping the entire reception, dropping only the reception for the overlapping resources (based on rate matching or puncturing), or supporting DL reception through the UL subband or the guard band according to the resource allocation information from the base station. The base station may be defined to configure or indicate, explicitly or implicitly, which of the above DL reception options is to be applied by a terminal. As an explicit configuration/indication method, the base station may configure the option via UE-specific or cell-specific RRC signaling. For this purpose, a dedicated RRC message or information element may be defined, or the SBFD-DL BWP configuration information, the UL subband configuration information, or the resource configuration information for the corresponding downlink physical channel/physical signal may be defined to include the DL reception option setting information. Alternatively, the DL reception option indication information may be delivered via a UE-specific or group-common PDCCH. For this, a dedicated DCI format may be defined, or an existing DCI format may be extended to include a field for the option indication information. In particular, the option indication information may be defined to be included in the DCI that delivers the resource allocation information for the corresponding downlink physical channel/physical signal.

### Second Disclosure: Configuration of Uplink Channels/Signals and Downlink Channels/Signals Supported in UL Subbands and DL Subbands

The base station may be defined to configure or indicate the radio channels or radio signals supported through the DL subband or UL subband of the SBFD symbol.

Specifically, when configuring a UL subband, when configuring the SBFD-UL BWP as described in the first disclosure, or when configuring a DL BWP or UL BWP that includes a UL subband in cases where a separate SBFD-UL BWP is not defined, the base station may be defined to configure or indicate whether uplink transmission through the UL subband is supported for each uplink physical channel or physical signal. For example, the base station may configure, via UE-specific or cell-specific higher layer signaling, whether the terminal supports PUCCH or SRS transmission through the UL subband. Alternatively, such support may be indicated through MAC control element (CE) signaling or L1 control signaling. Additionally, whether to support uplink transmission through the UL subband for a specific uplink physical channel or physical signal may be defined to depend on the triggering method or repetition configuration of the corresponding uplink physical channel or physical signal. For instance, UL subband transmission may be supported only for PUCCH or SRS transmissions for which repetition has been configured or indicated.

Similarly, the base station may be defined to configure or indicate whether downlink radio channels or radio signals are supported through the DL subband in an SBFD symbol. Specifically, the base station may configure or indicate, for each downlink physical channel or physical signal, whether to support downlink transmission and reception through the DL subband when configuring a UL subband, when configuring a DL subband, when configuring the SBFD-DL BWP as described above, or when configuring a DL BWP that includes a UL subband or a UL BWP that includes a DL subband in cases where a separate SBFD-DL BWP is not defined. For example, the base station may configure this support via UE-specific or cell-specific higher layer signaling or indicate it through MAC control element (CE) signaling or L1 control signaling for PDCCH transmission or CSI-RS transmission through the DL subband.

Hereinafter, embodiments for uplink transmission and downlink reception operations of a terminal in a SBFD symbol, in which UL subband, DL subband, and corresponding guard band configurations for full duplex communication are performed according to the first and second disclosures described above, are described.

### Embodiments of the Present Specification

For a terminal, an SBFD-DL BWP or SBFD-UL BWP may be defined for downlink reception or uplink transmission in an SBFD symbol. In this case, each SBFD-DL BWP has a linkage relationship with a UL BWP having the same index, and each SBFD-UL BWP has a linkage relationship with a DL BWP having the same index. For a terminal, the SBFD-DL BWP and SBFD-UL BWP may be configured for one DL BWP and one UL BWP, respectively, among the DL BWP(s) and UL BWP(s) configured for the terminal. That is, the base station may configure, via higher layer signaling, up to M (e.g., M=1) DL-UL BWP pairs as special DL-UL BWP pairs supporting UL subband and DL subband configuration for SBFD operation, selected from up to N (e.g., N=4) DL-UL BWP pairs configured for any terminal supporting SBFD. Alternatively, without association configuration through separate higher layer signaling, it may be restricted such that a specific DL-UL BWP pair among the DL-UL BWP pairs configured for a given terminal is determined as the SBFD-associated DL-UL BWP pair. For example, it may be defined that the initial DL/UL BWP or the DL/UL BWP pair with BWP identity (ID)=0 is determined as the SBFD-associated DL-UL BWP pair.

When an SBFD-DL BWP is activated for a terminal, the terminal may perform downlink reception through the DL subband in all SBFD symbols or in all SBFD symbols configured as DL according to the existing UL-DL configuration. When an SBFD-UL BWP is activated for a terminal, the terminal may perform uplink transmission through the UL subband in all SBFD symbols.

That is, when a UL subband configuration and the corresponding SBFD symbols are configured for a terminal, the terminal may be defined to perform uplink transmission through the UL subband in all SBFD symbols or to perform operations according to the original symbol configuration in all SBFD symbols. Here, the operation according to the original symbol configuration means that, as described above, the terminal performs downlink reception for DL symbols based on the ‘tdd-UL-DL-ConfigurationCommon’ and/or ‘tdd-UL-DL-ConfigurationDedicated’ settings, and performs downlink reception or uplink transmission on flexible symbols according to the base station's indication.

Additionally, the two operation modes for SBFD symbols are i) performing uplink transmission through the UL subband in all SBFD symbols or ii) performing operations according to the original symbol configuration in all SBFD symbols, and the choice between the two operation modes may be implicitly determined by defining a special bandwidth part (i.e., an SBFD-DL BWP or SBFD-UL BWP) and activating that bandwidth part. Alternatively, without additional definition of a special bandwidth part, one of the two operation modes, either i) performing uplink transmission through the UL subband in all SBFD symbols or ii) performing operations according to the original symbol configuration in all SBFD symbols, may be mapped to each DL BWP-UL BWP pair configured for a terminal. The mode to be applied in all SBFD symbols may then be implicitly determined by activating the corresponding DL BWP-UL BWP pair.

Alternatively, the two operation modes in SBFD symbols may be configured by the base station via RRC signaling or explicitly indicated through MAC CE signaling or L1 control signaling. They may also be implicitly determined by the UL subband configuration. For example, when a UL subband is configured for a terminal, uplink transmission may be defined to be performed through the UL subband at all SBFD symbols including the UL subband.

Alternatively, when the base station configures one SBFD-associated DL-UL BWP pair that supports UL subband and DL subband configuration for SBFD operation among up to four DL-UL BWP pairs configured for a terminal, the configuration information of the SBFD-associated DL-UL BWP pair may further include SBFD slot configuration information. The SBFD slot configuration information may refer to settings that indicates whether, in SBFD symbols where UL subband and DL subband configurations are applied, the terminal performs downlink reception through the DL subband (i.e., SBFD-DL symbols), performs uplink transmission through the UL subband (i.e., SBFD-UL symbols), or additionally performs flexible operations in which both downlink reception through the DL subband and uplink transmission through the UL subband are possible based on additional indications from the base station (i.e., SBFD-flexible symbols). For example, when SBFD symbols including the UL subband and DL subband are repeated periodically based on a period P according to periodic time resource allocation information for the UL subband and DL subband, configuration information regarding the number of SBFD-DL symbols and the number of SBFD-UL symbols within one period P for all SBFD symbols may be included in the configuration information of the SBFD-associated DL-UL BWP pair described above.

Accordingly, whether a terminal performs downlink reception through the DL subband and/or uplink transmission through the UL subband within a SBFD symbol may be determined at least based on the activation of the corresponding DL/UL BWP pair. That is, when the base station activates the SBFD-associated DL/UL BWP pair, among the DL/UL BWP pairs configured for a terminal, the terminal does not follow the existing slot configuration in SBFD symbols (i.e., does not follow the symbol configuration based on ‘tdd-UL-DL-ConfigurationCommon’ or ‘tdd-UL-DL-ConfigurationDedicated’), but instead follows, at least for the SBFD symbols, the SBFD symbol configuration information (i.e., SBFD-DL, SBFD-UL, or SBFD-flexible) included in the configuration of the SBFD-associated DL/UL BWP. In contrast, when a non-SBFD-associated DL/UL BWP pair (i.e., a normal DL/UL BWP pair other than the SBFD-associated DL/UL BWP pair) is activated, the terminal may follow the existing slot configuration even in SBFD symbols.

Meanwhile, for a terminal in which downlink reception is determined in an SBFD symbol, the frequency resources for DL reception in that SBFD symbol may be limited to the DL subband, or reception may be allowed over the entire frequency resources of the DL BWP, including the UL subband and the guard band. This configuration may be performed by the base station via RRC signaling. In particular, the configuration information may be included as part of the UL subband configuration.

Additionally, the uplink radio channels and radio signals and the downlink radio channels and radio signals that are supported for transmission and reception through the UL subband or DL subband in a SBFD symbol may be configured by the base station via RRC signaling.

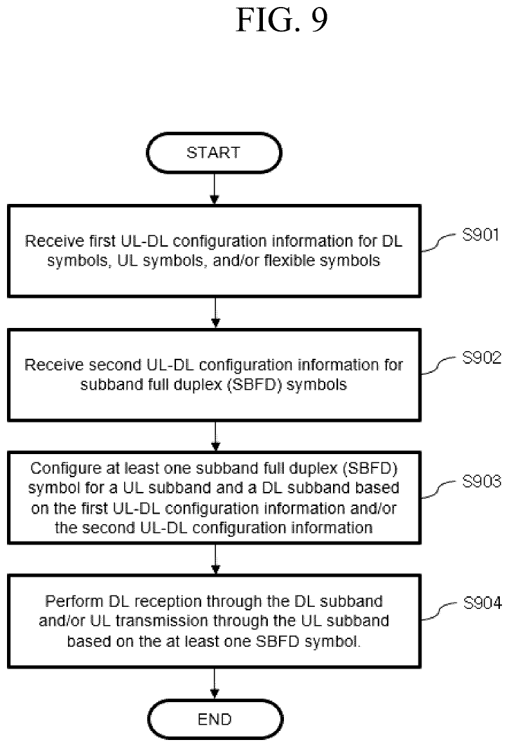

FIG. 9 is a flowchart illustrating an operation method of a terminal according to an embodiment of the disclosure.

Referring to FIG. 9, a terminal receives first UL-DL configuration information for downlink (DL) symbols, uplink (UL) symbols, and/or flexible symbols from a base station (S901). In addition, the terminal receives second UL-DL configuration information for subband full duplex (SBFD) symbols from the base station (S902). Thereafter, the terminal configures, based on the received first UL-DL configuration information and/or second UL-DL configuration information, at least one SBFD symbol for a UL subband and a DL subband (S903). Then, the terminal performs DL reception through the DL subband and/or UL transmission through the UL subband based on the at least one SBFD symbol (S904). Here, the at least one SBFD symbol may be determined as a symbol for the DL reception and/or the UL transmission by: i) applying the second UL-DL configuration information through activation of a specific bandwidth part (BWP), or ii) applying the first UL-DL configuration information through activation of a non-specific bandwidth part.

The specific bandwidth part may correspond to one of DL/UL bandwidth part pairs configured for the terminal, and the non-specific bandwidth part may correspond to remaining DL/UL bandwidth part pairs excluding the specific bandwidth part.

Alternatively, the non-specific bandwidth part may correspond to DL/UL bandwidth part pairs configured for the terminal, and the specific bandwidth part may correspond to a specific DL/UL bandwidth part pair additionally configured beyond the DL/UL bandwidth part pairs configured for the terminal.

Further, the specific bandwidth part may be configured through radio resource control (RRC) signaling, may be determined as an initial DL/UL bandwidth part pair among the DL/UL bandwidth part pairs configured for the terminal, or may be determined as a DL/UL bandwidth part pair having a bandwidth part (BWP) identity of 0.

The first UL-DL configuration information and/or the second UL-DL configuration information may be received through radio resource control (RRC) signaling.

The DL reception through the DL subband may be performed as configured per DL channel and/or per DL signal, and the UL transmission through the UL subband is performed as configured per UL channel and/or per UL signal.

In addition, the UL transmission through the UL subband is performed based on whether repetitive transmission is configured for a UL channel and/or a UL signal.

Further, the first UL-DL configuration information and/or the second UL-DL configuration information may be cell-specific or UE-specific.

The disclosures described herein may be applied independently or may be combined and operated in any form. Although the present disclosure is described based on a 5G NR system, the concepts of the present disclosure are not limited to any specific wireless communication technology and may be applicable to any system or scenario to which the concepts are applicable, and such cases are considered to fall within the scope of the present disclosure.

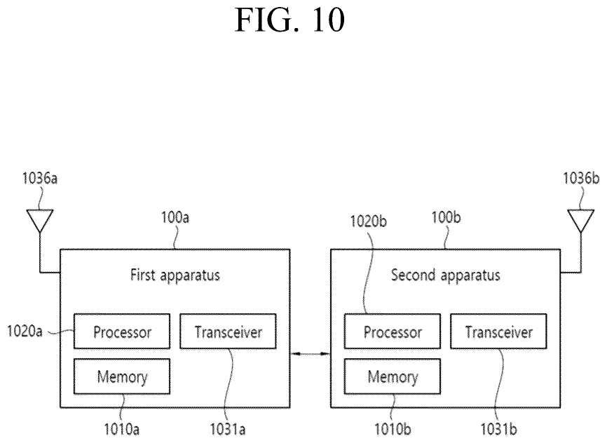

FIG. 10 shows apparatuses according to an embodiment of the disclosure.

Referring to FIG. 10, a wireless communication system may include a first apparatus 100a and a second apparatus 100b.

The first apparatus 100a may include a base station, a network node, a transmission user equipment (UE), a reception UE, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The second apparatus 100b may include a base station, a network node, a transmission UE, a reception UE, a wireless apparatus, a radio communication device, a vehicle, a vehicle with an autonomous driving function, a connected car, an unmanned aerial vehicle (UAV), an artificial intelligence (AI) module, a robot, an augmented reality (AR) apparatus, a virtual reality (VR) apparatus, a mixed reality (MR) apparatus, a hologram apparatus, a public safety apparatus, a machine-type communication (MTC) apparatus, an Internet of things (IoT) apparatus, a medial apparatus, a finance technology (FinTech) apparatus (or a financial apparatus), a security apparatus, a climate/environment apparatus, an apparatus related to a 5G service, or other apparatuses related to the fourth industrial revolution.

The first apparatus 100a may include at least one processor such as a processor 1020a, at least one memory such as a memory 1010a, and at least one transceiver such as a transceiver 1031a. The processor 1020a may perform the foregoing functions, procedures, and/or methods. The processor 1020a may implement one or more protocols. For example, the processor 1020a may perform one or more layers of a radio interface protocol. The memory 1010a may be connected to the processor 1020a and configured to various types of information and/or instructions. The transceiver 1031a may be connected to the processor 1020a and controlled to transceive a radio signal.

The second apparatus 100b may include at least one processor such as a processor 1020b, at least one memory device such as a memory 1010b, and at least one transceiver such as a transceiver 1031b. The processor 1020b may perform the foregoing functions, procedures, and/or methods. The processor 1020b may implement one or more protocols. For example, the processor 1020b may implement one or more layers of a radio interface protocol. The memory 1010b may be connected to the processor 1020b and configured to store various types of information and/or instructions. The transceiver 1031b may be connected to the processor 1020b and controlled to transceive radio signaling.

The memory 1010a and/or the memory 1010b may be respectively connected inside or outside the processor 1020a and/or the processor 1020b and connected to other processors through various technologies such as wired or wireless connection.

The first apparatus 100a and/or the second apparatus 100b may have one or more antennas. For example, an antenna 1036a and/or an antenna 1036b may be configured to transceive a radio signal.

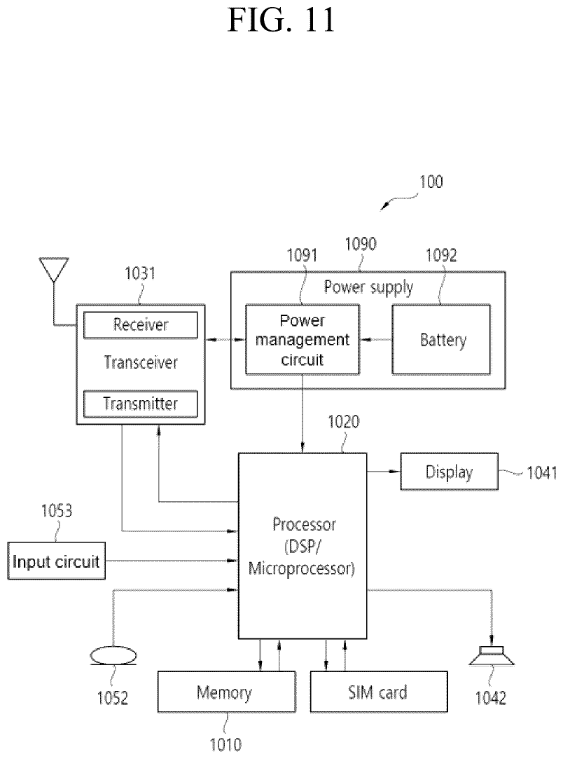

FIG. 11 is a block diagram showing a configuration of a terminal according to an embodiment of the disclosure.

In particular, FIG. 11 illustrates the foregoing apparatus of FIG. 10 in more detail.

The apparatus includes a memory 1010, a processor 1020, a transceiver 1031, a power management circuit 1091, a battery 1092, a display 1041, an input circuit 1053, a loudspeaker 1042, a microphone 1052, a subscriber identification module (SIM) card, and one or more antennas.

The processor 1020 may be configured to implement the proposed functions, procedures, and/or methods described in the disclosure. The layers of the radio interface protocol may be implemented in the processor 1020. The processor 1020 may include an application-specific integrated circuit (ASIC), other chipsets, logic circuits, and/or data processing devices. The processor 1020 may be an application processor (AP). The processor 1020 may include at least one of a digital signal processor (DSP), a central processing unit (CPU), a graphics processing unit (GPU), and a modulator and demodulator (MODEM). For example, the processor 1020 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel®, KIRIN™ series of processors made by HiSilicon®, or the corresponding next-generation processors.

The power management circuit 1091 manages a power for the processor 1020 and/or the transceiver 1031. The battery 1092 supplies power to the power management module 1091. The display 1041 outputs the result processed by the processor 1020. The input circuit 1053 receives an input to be used by the processor 1020. The input unit 1053 may be displayed on the display 1041. The SIM card is an integrated circuit used to safely store international mobile subscriber identity (IMSI) used for identifying a subscriber in a mobile telephoning apparatus such as a mobile phone and a computer and the related key. Many types of contact address information may be stored in the SIM card.

The memory 1010 is coupled with the processor 1020 in a way to operate and stores various types of information to operate the processor 1020. The memory may include read-only memory (ROM), random access memory (RAM), flash memory, a memory card, a storage medium, and/or other storage device. When the embodiment is implemented in software, the techniques described in the present disclosure may be implemented in a module (e.g., process, function, etc.) for performing the function described in the present disclosure. A module may be stored in the memory 1010 and executed by the processor 1020. The memory may be implemented inside of the processor 1020. Alternatively, the memory 1010 may be implemented outside of the processor 1020 and may be connected to the processor 1020 in communicative connection through various means which is well-known in the art.

The transceiver 1031 is connected to the processor 1020 in a way to operate and transmits and/or receives a radio signal. The transceiver 1031 includes a transmitter and a receiver. The transceiver 1031 may include a baseband circuit to process a radio frequency signal. The transceiver controls one or more antennas to transmit and/or receive a radio signal. In order to initiate a communication, the processor 1020 transfers command information to the transceiver 1031 to transmit a radio signal that configures a voice communication data. The antenna functions to transmit and receive a radio signal. When receiving a radio signal, the transceiver 1031 may transfer a signal to be processed by the processor 1020 and transform a signal in baseband. The processed signal may be transformed into audible or readable information output through the speaker 1042.

The speaker 1042 outputs a sound related result processed by the processor 1020. The microphone 1052 receives a sound related input to be used by the processor 1020.

A user inputs command information like a phone number by pushing (or touching) a button of the input unit 1053 or a voice activation using the microphone 1052. The processor 1020 processes to perform a proper function such as receiving the command information, calling a call number, and the like. An operational data on driving may be extracted from the SIM card or the memory 1010. Furthermore, the processor 1020 may display the command information or driving information on the display 1041 for a user's recognition or for convenience.

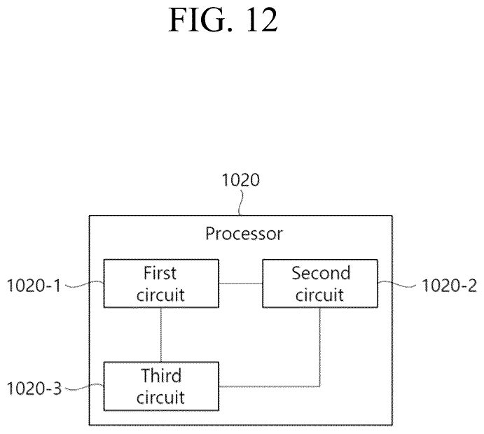

FIG. 12 is a configuration block diagram of a processor in which the disclosure is implemented.

Referring to FIG. 12, a processor 1020 may include a plurality of circuitry to implement the proposed functions, procedures and/or methods described herein. For example, the processor 1020 may include a first circuit 1020-1, a second circuit 1020-2, and a third circuit 1020-3. Also, although not shown, the processor 1020 may include more circuits. Each circuit may include a plurality of transistors.

The processor 1020 may be referred to as an application-specific integrated circuit (ASIC) or an application processor (AP). The processor 1020 may include at least one of a digital signal processor (DSP), a central processing unit (CPU), and a graphics processing unit (GPU).

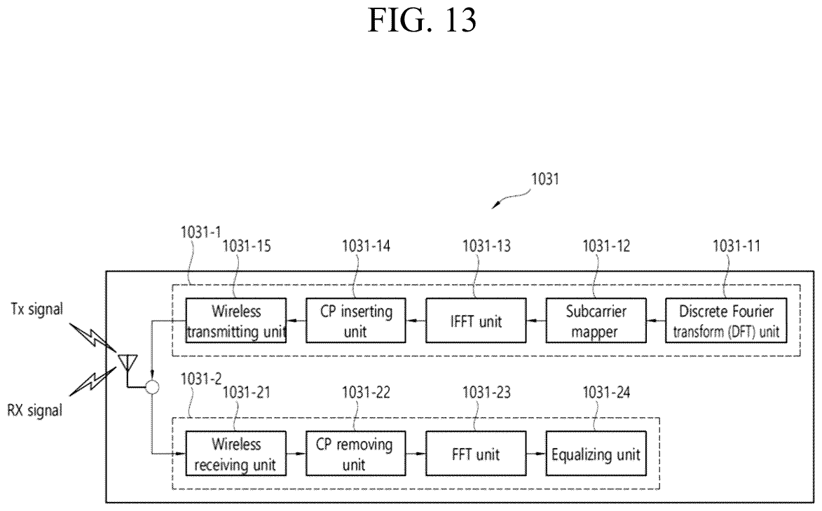

FIG. 13 is a detailed block diagram of a transceiver of a first apparatus shown in FIG. 10 or a transceiving unit of an apparatus shown in FIG. 11.

Referring to FIG. 13, the transceiving unit 1031 includes a transmitter 1031-1 and a receiver 1031-2. The transmitter 1031-1 includes a discrete Fourier transform (DFT) unit 1031-11, a subcarrier mapper 1031-12, an IFFT unit 1031-13, a cyclic prefix (CP) insertion unit 1031-14, and a wireless transmitting unit 1031-15. The transmitter 1031-1 may further include a modulator. Further, the transmitter 1031-1 may for example include a scramble unit (not shown), a modulation mapper (not shown), a layer mapper (not shown), and a layer permutator (not shown), which may be disposed before the DFT unit 1031-11. That is, to prevent a peak-to-average power ratio (PAPR) from increasing, the transmitter 1031-1 subjects information to the DFT unit 1031-11 before mapping a signal to a subcarrier. The signal spread (or pre-coded) by the DFT unit 1031-11 is mapped onto a subcarrier by the subcarrier mapper 1031-12 and made into a signal on the time axis through the IFFT unit 1031-13. Some of constituent elements is referred to as a unit in the disclosure. However, the embodiments are not limited thereto. For example, such term “unit” is also referred to as a circuit block, a circuit, or a circuit module.

The DFT unit 1031-11 performs DFT on input symbols to output complex-valued symbols. For example, when Ntx symbols are input (here, Ntx is a natural number), DFT has a size of Ntx. The DFT unit 1031-11 may be referred to as a transform precoder. The subcarrier mapper 1031-12 maps the complex-valued symbols onto respective subcarriers in the frequency domain. The complex-valued symbols may be mapped onto resource elements corresponding to resource blocks allocated for data transmission. The subcarrier mapper 1031-12 may be referred to as a resource element mapper. The IFFT unit 1031-13 performs IFFT on the input symbols to output a baseband signal for data as a signal in the time domain. The CP inserting unit 1031-14 copies latter part of the baseband signal for data and inserts the latter part in front of the baseband signal for data. CP insertion prevents inter-symbol interference (ISI) and inter-carrier interference (ICI), thereby maintaining orthogonality even in a multipath channel.

On the other hand, the receiver 1031-2 includes a wireless receiving unit 1031-21, a CP removing unit 1031-22, an FFT unit 1031-23, and an equalizing unit 1031-24. The wireless receiving unit 1031-21, the CP removing unit 1031-22, and the FFT unit 1031-23 of the receiver 1031-2 perform reverse functions of the wireless transmitting unit 1031-15, the CP inserting unit 1031-14, and the IFFT unit 1031-13 of the transmitter 1031-1. The receiver 1031-2 may further include a demodulator.

Although the preferred embodiments of the disclosure have been illustratively described, the scope of the disclosure is not limited to only the specific embodiments, and the disclosure can be modified, changed, or improved in various forms within the spirit of the disclosure and within a category written in the claim.

In the above exemplary systems, although the methods have been described in the form of a series of steps or blocks, the disclosure is not limited to the sequence of the steps, and some of the steps may be performed in different order from other or may be performed simultaneously with other steps. Further, those skilled in the art will understand that the steps shown in the flowcharts are not exclusive and may include other steps or one or more steps of the flowcharts may be deleted without affecting the scope of the disclosure.

Claims of the present disclosure may be combined in various manners. For example, technical features of the method claim of the present disclosure may be combined to implement a device, and technical features of the device claim of the present disclosure may be combined to implement a method. In addition, the technical features of the method claim and the technical features of the device claim of the present disclosure may be combined to implement a device, and technical features of the method claim and the technical features of the device claim of the present disclosure may be combined to implement a method.

1-20. (canceled)

21. A method for a terminal to perform uplink (UL) transmission and downlink (DL) reception in a wireless communication system, the method comprising:
receiving UL subband configuration information and DL subband configuration information for subband full duplex (SBFD) symbols;
determining at least one SBFD symbol based on the UL subband configuration information and the DL subband configuration information; and
performing the UL transmission through the UL subband and the DL reception through the DL subband in the determined at least one SBFD symbol,
wherein the UL transmission and the DL reception are performed based on i) UL transmission support and ii) DL reception support, which are configured for the at least one SBFD symbol.

22. The method of claim 21, wherein the UL transmission support and the DL reception support configured for the at least one SBFD symbol are based on a UL bandwidth part (BWP) and a DL BWP, respectively.

23. The method of claim 21, wherein the UL transmission support configured for the at least one SBFD symbol is applied differently to each UL physical channel and each UL physical signal.

24. The method of claim 21, wherein the DL reception support configured for the at least one SBFD symbol is applied differently to each DL physical channel and each DL physical signal.

25. The method of claim 21, wherein the UL transmission support and the DL reception support are configured for the at least one SBFD symbol through radio resource control (RRC) signaling.

26. The method of claim 23, wherein the UL transmission support configured for the at least one SBFD symbol is based on a repetition configuration for at least one of the UL physical channel and the UL physical signal.

27. The method of claim 25, wherein the RRC signaling is cell-specific or terminal-specific.

28. A terminal in a wireless communication system, the terminal comprising:
at least one processor; and
at least one memory configured to store instructions and be operably electrically connectable to the at least one processor,
wherein operations performed based on the instructions executed by the at least one processor comprise:
receiving UL subband configuration information and DL subband configuration information for subband full duplex (SBFD) symbols;
determining at least one SBFD symbol based on the UL subband configuration information and the DL subband configuration information; and
performing the UL transmission through the UL subband and the DL reception through the DL subband in the determined at least one SBFD symbol,
wherein the UL transmission and the DL reception are performed based on i) UL transmission support and i) DL reception support, which are configured for the at least one SBFD symbol.

29. The terminal of claim 28, wherein the UL transmission support and the DL reception support configured for the at least one SBFD symbol are based on a UL bandwidth part (BWP) and a DL BWP, respectively.

30. The terminal of claim 28, wherein the UL transmission support configured for the at least one SBFD symbol is applied differently to each UL physical channel and each UL physical signal.

31. The terminal of claim 28, wherein the DL reception support configured for the at least one SBFD symbol is applied differently to each DL physical channel and each DL physical signal.

32. The terminal of claim 28, wherein the UL transmission support and the DL reception support are configured for the at least one SBFD symbol through radio resource control (RRC) signaling.

33. The terminal of claim 30, wherein the UL transmission support configured for the at least one SBFD symbol is based on a repetition configuration for at least one of the UL physical channel and the UL physical signal.

34. The terminal of claim 32, wherein the RRC signaling is cell-specific or terminal-specific.
